(19) United States
(12) Patent Application Publication
(10) Pub. No.: US 2009/0026839 A1
(43) Pub. Date: Jan. 29, 2009

(54) Wearable/portable power and communications device

(76) Inventor: Olav Drageset, Oslo (NO)

Correspondence Address: BIRCH STEWART KOLASCH & BIRCH, PO BOX 747, FALLS CHURCH, VA, 22040-0747, US

(21) Appl. No.: 11/920,921

(22) PCT Filed: May 24, 2006
(86) PCT No.: PCT/NO2006/000194

§ 371 Date: Nov. 21, 2007

(30) Foreign Application Priority Data
May 27, 2005 (NO) 2005 2590

(51) Int. Cl. H02J 1/14

(52) U.S. Cl. 307/32

(57) ABSTRACT

An electric connect/disconnect device (1) for electronic, wearable equipment and for arrangement between an electric power consuming circuit (2) and an electric power supply module (3) of the electronic, wearable equipment, and adapted for use in managing the energy supply and consumption of the electronic, wearable equipment wherein a controllable switch device (4) can switch an electric connection (5) from a power consuming circuit (2) to the supply module (3) between a connect state and a disconnect state. A wearable electric power and information system comprises an electric power consuming circuit (2), an electric power supply module (3), and a connect/disconnect device (1) The connect and disconnect (1) device is controlled by a control unit (7) of the wearable electronic system.

### FIELD OF THE INVENTION

This invention is related to electronic information systems and in particular to wearable electronic information systems where at least some of the components are worn by a person, such as e.g. an information system integrated fully or partly with the clothing and equipment carried by a person, and the electric power supply related with such systems.

### BACKGROUND OF THE INVENTION

A wearable information system is carried by a person or persons as part of the personal equipment. The information system typically includes features for storing some type of information on and/or related to the person. Often the system may have a wireless connection for information exchange and cooperation with other wearable information systems and with stationary units in a wider information network.

Typically, a wearable information system has means for providing the person carrying the system with information and means for entering or accepting input of information into the system.

Present electronic information systems allow for multimedia technology, i.e. a combination of embedded data, audio and visual information will be handled by such a system. As a number of electronic devices now are available in lightweight versions, it is possible to introduce a wide range of types of electronic units into the wearable information system at various settings, such as e.g. wireless communication (radio), GPS (Global Positioning System) units, night vision devices, range finders (e.g. laser based), data communication terminals, encryption units, camera devices, etc.

At present each of these additional units have their own power source units, such as battery supply modules, embedded in the unit. Hence, a limitation arises in many situations due to the demand for ensuring adequate supplies of batteries to the user(s).

Traditional development has focused on integrating all electronic devices into a single unit in order that one common battery may supply all devices.

Wearable soldier systems are presently emerging. There are soldier systems known to this inventor/applicant in which a central unit acts as a distribution point for electric power to the electronic devices of the system. In different versions of such soldier systems battery may be a part of the central unit or battery power may be supplied to a common distribution point via cable.

In the wider field of electronic information systems it is at present commonly known to distribute data signals and regulated power via a common cable in commercial systems based on standardized concepts, such as e.g. USB (www.usb.org) and Ethernet communication (www.poweroverethernet.com). Theses standards have an inherent limitation in the available power, i.e. there is insufficient power available for a number of devices frequently used in wearable systems.

A combination of data distribution and unregulated battery voltage distribution is also known in one soldier system (U.S. Land Warrior program) known to this inventor/applicant. It is a limitation of these high power distribution systems that a fault in a connector or power supply chain component may compromise system operability of such wearable electronic information systems to a too large extent.

In addition there are at present no agreed upon common interface standard around which such wearable electronic information systems could be designed. This fact tends to make such systems more complicated than would be desirable. An improved solution which could increase the trend towards standardization within this field would presumably be beneficial for many manufacturers as this would lead to some simplification.

### OBJECTIVES OF THE INVENTION

Hence, it is a first object of the present invention to provide solutions which supplies sufficient power to and increase the flexibility in configuring and designing such wearable electronic information systems while still maintaining a high degree of system integrity and operability in the case of faults in the components of the system.

A second object of the present invention is to provide a solution which is able to make more efficient use of available power sources of wearable electronic information systems without compromising system integrity.

A third objective of the invention is to provide solutions which enable a higher degree of standardization in the connection of power supplying units and power consuming units into wearable electronic information systems.

### THE INVENTION

In order to meet one or more of the above stated objectives, there is thus according to the invention provided an electric connect/disconnect device for electronic, wearable equipment and for arrangement between an electric power consuming circuit and an electric power supply module of the electronic, wearable equipment. The device is adapted for use in managing the energy supply and consumption of the electronic, wearable equipment using a controllable switch device which can switch an electric connection from a power consuming circuit to the supply module between a connect state and a disconnect state.

In a preferable embodiment of the electric connect/disconnect device according to the invention the controllable switch device is arranged between a power consuming circuit and an electric power supply module. This way each power consumer device and power supplying device can be individually connected or disconnected from a system.

In yet a preferable embodiment of the electric connect/disconnect device according to the invention the switch device comprises a current path split in two current paths connected in parallel, a first path for conducting current in one direction and a second path for conducting current in a direction opposite to the current direction of said first path through the connect/disconnect device. This way a device connected can be set up either to be a power consumer only or a power supplier only in the system, and the configuration can be changed according to a current situation or a current configuration of a system. In an alternative preferable embodiment of the electric connect/disconnect device according to the invention the said first and second current path each comprises a diode function for conducting current in one direction, the diode function in the first path being connected in the opposite direction to the diode function in the second path.

In another alternative the each of said parallel current paths comprise a separate switch function whereby current can be broken separately in for each parallel path, by a control signal from a control unit.

In still a preferable embodiment of the electric connect/disconnect device according to the invention each of said parallel current paths comprise a FET (Field Effect Transistor).

In still yet a preferable embodiment of the electric connect/disconnect device according to the invention the electric connection comprise electric conductors for transfer of communication signals and/or electric power, and wherein electric conductors for transferring communication signals are included in a USB-connection between the supply module (4) and the power consuming circuit.

In a further preferable embodiment of the electric connect/disconnect device according to the invention an input/output line is provided for the output/input of signals containing information related to the setting and characteristics of the connect/disconnect device, and which is adapted to receive information related to the settings of the input/output device via said input/output line, said received information including a setting which depend on any fused devices to enable a fault dependent and fault tolerant overall system. In a further still preferable embodiment of the electric connect/disconnect device according to the invention it is adapted to provide or receive information via said input/output line, said information including an on/off status of the electric connections for transfer of electric power. In yet a further still preferable embodiment of the electric connect/disconnect device according to the invention a voltage sense output enables transfer of a signal representing a voltage at the connect/disconnect device to a control unit, and a current sense output enables transfer of a signal representing a current through the connect/disconnect device to a control unit.

In an even preferable embodiment of the electric connect/disconnect device according to the invention the current measuring circuit is adapted to measure current in one or both directions in at least one electric conductor supplying electric power.

According to the invention there is in a second aspect provided a wearable electric power and information system comprising an electric power consuming circuit, an electric power supply module, and a connect/disconnect device arranged between the power consuming circuit and the power supply module wherein the connect/disconnect device comprises a switch device capable switching an electric connection from the power consuming circuit to the supply module between a connect and a disconnect state. The connect and disconnect device is controlled by a control unit of the wearable electronic system.

In a preferable embodiment of the electric power and information system according to the second aspect of the invention the connect disconnect device is arranged between power consuming circuit and an electric power supply module.

In yet a preferable embodiment of the electric power and information system according to the second aspect of the invention a power management program code is running in a program executing module of the wearable electronic system.

In a still preferable embodiment of the electric power and information system according to the second aspect of the invention the connect/disconnect device comprises a controllable fuse circuit which can break or interrupt electric connections between the power consuming circuit and the power supply module.

### THE DRAWINGS

The invention will be described in detail below with reference to the appended drawings in which

FIG. 1 shows a prior art solution to power distribution in wearable information systems.

FIG. 2 is a schematic block diagram of an embodiment of an electric connect/disconnect device according to the invention in a wearable/portable electric system according to the invention.

FIG. 3 illustrates in some detail an example of an electric connect and disconnect device (Gatekeeper) according to the invention.

FIG. 4A illustrates one example embodiment of the electric connect and disconnect device according to the invention in more detail.

FIG. 4B illustrates a second example embodiment of the electric connect and disconnect device according to the invention in more detail.

FIG. 5 illustrates one example embodiment of a system according to the invention.

### DETAILED DESCRIPTION OF THE INVENTION

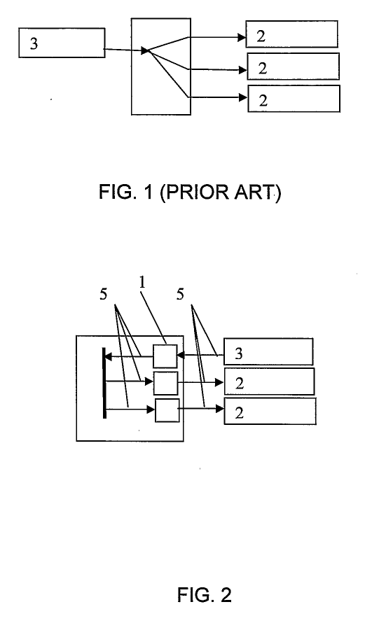

In the prior art a power distribution system for wearable/portable electronic systems or similar stand-alone systems have typically been implemented as illustrated in FIG. 1. A single provider of electric power supplies power to a distribution unit. From the distribution unit there is a separate power connection to each consumer module.

FIG. 2 illustrates an electric power and information system according to this invention electronic. The system has two electric power consuming circuits (Consumer) 2, an electric power supply module (Provider) 3, and three electric connect/disconnect devices 1 according to this invention arranged between the power consuming circuit 2 and the power supply module 3. For the purposes of this description the electric connect/disconnect devices 1 according to this invention are called Gatekeepers. Each Gatekeeper 1 comprises at least one switch or fuse device 4 capable of establishing and breaking an electric connection 5 between the power consuming circuits 2 and the supply module 3, and each Gatekeeper may be controlled by a power management system of the electric power and information system. The electric connections 5 can have the same interface for all units, regardless if they are providers or consumers of electric power.

Thus, there is provided an electric power and information system in the form of a portable or wearable electric system having at least one electric power providing module 3 and at least one electric power consuming module 2. Although FIG. 2 shows a system with one power supply module 3 and two power consuming circuits 2, it will be apparent to anyone skilled in the art that it is intended that more than one power supply module 3 may be connected to the system in the same manner as the one shown, and also that more than two power consuming circuits 2 may in the same manner be connected to the system. Normally, the number of connectors 10 available will set an upper limit to the possible number of devices to connect to the system.

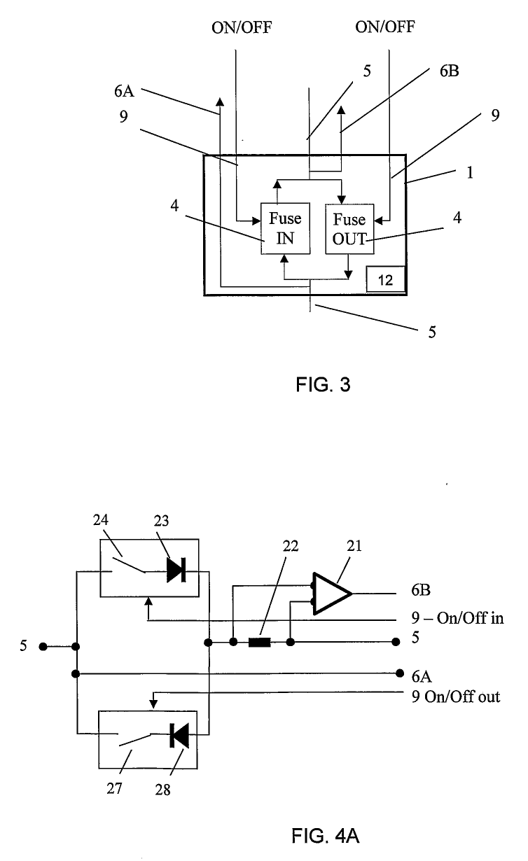

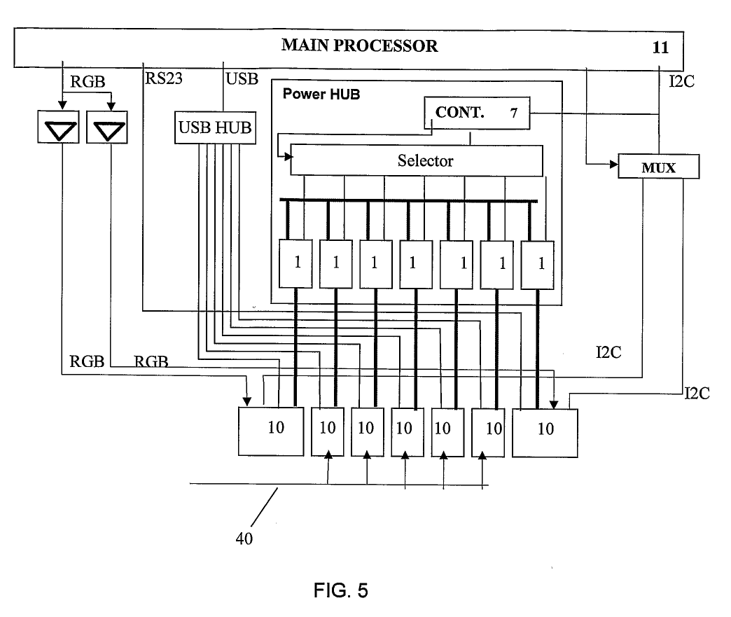

FIG. 3 illustrates the main internal connections of one embodiment of the electric connect/disconnect device (Gatekeeper) 1 according to the invention. Electric current through the gatekeeper is split into two separate paths by means of a device having diode-like functionality (current conducted only in one direction in each current path, i.e. in one direction in the first current path and in the opposite direction in the second current path). The first current path may be called the inward path (allowing power/current to enter from a single device and into the system), and the second current path may be called the outward path (for allowing power/current to be supplied from the system to a connected device). A fuse device 4 is inserted into each current path. The fuse devices can break the current separately for the inward and outward paths. The conduct/break states of the fuses are controlled by a control signal from control unit 7, as illustrated in FIG. 5.

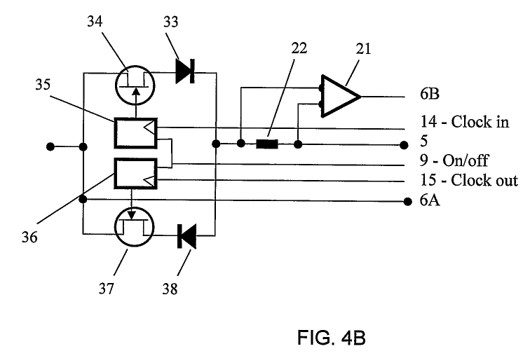

FIG. 4A illustrates one embodiment of the electric connect and disconnect device (Gatekeeper) according to the invention in some more detail. The power line is indicated with numeral 5 as in FIG. 3. The current sense line 6B is shown to be provided with an amplifier 21 whose inputs are connected across a resistor 22, where the said resistor 22 is connected in a serial manner along the power and/or communications line 5. A first fuse device 23,24 for a first of the in/out lines is in FIG. 4A shown to comprise a first switch function 24 and a first diode function 23, whereas a second fuse device 27,28 for a second in/out line is shown comprising a second switch function 27 and a second diode function 28. For each fuse device the on/off switch for the conducted current may be controlled by an On/Off signal 9 provided by control unit 7 via selector 8 and signal line 9.

FIG. 4B illustrates a second embodiment of the electric connect and disconnect device (Gatekeeper) according to the invention in some more detail. The power and/or communications line is again indicated with numeral 5 as in FIG. 3. The current sense line 6B is shown to be provided by an amplifier 21 whose inputs are connected across a resistor 22, where the said resistor 22 is connected in a serial manner along the power and/or communications line 5. A first fuse device 33, 34, 35 for a first of the in/out lines is in FIG. 5 shown to comprise a first FET-transistor 34, a first diode 33 and a first control circuit 35, whereas a second fuse device 36,37,38 for the other in/out line is shown comprising a second FET-transistor 37, a second diode 38, and a second control circuit 36. For each fuse device the FET-transistors 34, 37 acts like on/off switches for the conducted current which may be controlled by a gate signal provided by the control circuits 35, 36. The control circuits 35, 36 are coupled via on/off signal line 9, clock in line 14, and clock out line 15 and possibly via multiplexer 8 to the control unit 7. Clock signals in line 14 and line 15 may be used to provide timing and synchronization of the operation of a multitude of Gatekeepers and possibly with other units connected to the system. Control circuits 35, 36 are typically integrated circuits (ICs) which sets the state of the transistor switch(es). Typically, the control circuits 35, 36 comprise a digital memory module for storing the information related to the setting of the transistor switch(es). Upon request, e.g. from the control unit 7, the control circuits 35, 36 may transmit a signal via one or more of the control lines 9, 14,15 to another unit, e.g. the control unit 7, where the signal represents the state of the transistor switch 34, 37.

The control unit 7 is thus able to obtain a measure of the voltage present at the external current providers/consumers (2,3) and/or the current going through the gatekeeper 1 and sets the fuse devices/switches 4 according to a rule (rules) based on voltage value(s), current value(s) and other criteria as determined by overall system operation, Normally, the basic rule will be to disconnect the current if the current increases past an absolute maximum current limit for more than a short time to allow for inrush current. A secondary rule would be to switch off the current if the current increases past a nominal maximum current limit which is set by system administration. This limit may depend on connected unit type. A third rule could be to switch off power supply to selected peripheral units in an emergency situation in order to keep alive critical functions for a longer time before batteries are empty. A fourth rule could be to switch off one battery until another battery is depleted.

The Gatekeeper control module 7 is shown as part of the Power Hub in FIG. 5. Normally, all control of the individual Gatekeepers 1 will be via the Gatekeeper Control Unit 7.

FIG. 5 illustrates a wearable electric power and information system according to the invention having a number of connect/disconnect devices 1 is shown. The system on FIG. 5 can be called a Torso computer. For simplicity, the electric power consuming circuits 2 and the electric power supply modules 3 which normally will be connected to the connectors 10 of the Torso computer are omitted. Also, the separate, normally internal, power supply of the Torso computer is not illustrated, but it will be apparent to anyone skilled in the art that the Torso computer will require a separate power supply. A main processor 11 and an electric connect/disconnect device control unit 7 which controls a number of electric connect/disconnect devices 1 of a wearable/portable electric system according to one embodiment of the invention is illustrated.

In FIG. 5 it is also illustrated how each Gatekeeper 1 is connected to connectors 10, where each connector 10 comprises at least one power connection and a digital communication connection in each connector 10. One of the connectors is also provided with an RS232 connection to a main processor, while two connectors are provided with I2C connections and RGB connections. Hence, an array of connectors enables a large number of devices to be connected to the power and information system illustrated in FIG. 5. RGB is a line which may provide a video signal to a display. I2C is a control bus running between two or more IC's. USB is a standard Universal Serial Bus connection which enables the connection of any USB-compliant device. RS232 is a serial line providing a possibility of interfacing with devices which require serial line communication. An interface bus 40 could also be interfaced via the connectors 10 between hub of a wearable electric power and information system according to the invention and each power consuming device 2 or power supplying device being a part of a larger system.

Further, FIG. 3 illustrates that a Gatekeeper may be provided with a voltage sense line from a Gatekeeper and to a control unit 7, as illustrated in FIG. 5, for providing a signal to the control unit 7 representing a voltage measurement at a Gatekeeper 1. In the same manner, a Gatekeeper 1 may be provided with a current sense line for providing a measurement of the current flowing in the electric connection 5 through the Gatekeeper 1 in question.

In FIG. 5 it is illustrated how a selector device, perhaps based on or comprising a multiplexing device, is inserted between the Gatekeeper control unit and each Gatekeeper. Analogue voltage sense 6A (and/or current sense 6B) signals illustrated in FIG. 3 are transferred to the Control Unit 7 via the selector device 8. In the control unit 7 the analogue voltage sense (and/or current sense) signals are converted to digital representations to enable further processing of the voltage/current signals using standard digital processing techniques and components.

The on/off status for the switch(es) 4 of the Gatekeeper(s) 1 is(are) set using signals which are passed through the selector device 8 and via control lines 9 to the Gatekeeper 1. The status of the switch(es) is(are) stored in the Gatekeeper. The control unit 7 requires only one set of inputs as it can set the selector device 8 to connect to any one of the Gatekeepers 1 at a time, thereby avoiding separate wiring for each Gatekeeper 1 all the way into the control unit 7.

When the electronic functions of the Gatekeeper are implemented for each distribution branch as explained in this description, a system is enabled where any unit connected to the system may be either a power provider or a power consumer or both, depending on the settings of the switch devices 4 of the Gatekeeper 1. The Gatekeeper may be provided with a digital register 12, the content of which reflects the on/off status of the switch device(s) 4 of the Gatekeeper 1. The content/status of the digital register(s) 12 of one, many or all of the Gatekeeper(s) 1 may be obtained by the gatekeeper control unit 7 via corresponding means of exchanging information between the Gatekeeper Control Unit 7 and the Gatekeeper 1.

Although in most of this description it is assumed that a Control module 7 is separate from a Gatekeeper 1, it should be envisaged that a control module 7 could also form an integrated part of a Gatekeeper 1. Thus integrated in the Gatekeeper 1 there will then be a control module 7 which is able, via the current or voltage sense line, to detect an abnormally high or low voltage and/or current on the power/communication line 5 passing through the Gatekeeper. Thereby a Gatekeeper 1 may be adapted, when predetermined conditions are satisfied, to disconnect a power consuming or power providing device by switching the fuse device(s) or the switch function of a Gatekeeper module to an OFF-state.

This new system is particularly well suited for use with a body computer, or a central computer in a wearable information system having a number of peripheral modules connected to it. The ports/connectors 10 of the body computer may all be equal, and a peripheral module may thus be connected to the body computer using any of the connectors 10. An external electric battery (not illustrated) may thus be connected to any of the connectors 10. In other words, either a power provider or a power consumer may be connected equally well to the same connector, and the associated Gatekeeper is adapted for bidirectional operation, as described in this invention. In the case of fault in one connector or port, the battery may be disconnected from the faulty connector/port and reconnected to another connector 10 in order to overcome the potential problem. The corresponding gatekeeper 1 may then be set to close the switch which will allow the battery to drive the remaining units of the system. In the case that a rechargeable battery is connected to the system, the corresponding Gatekeeper 1 may be set to allow a rechargeable battery to receive a charging current from any power source or charging unit connected to the system and capable of supplying a charging current.

It is thus beneficial that the ports have a standardized design and performance of the connector 10 in order that the connected units may easily be relocated from one connector 10 to another in the event of a faulty connector 10 or connector cable.

In another configuration the system may have two battery power supplies connected at two separate connectors, whereby one of the supplies may have a back-up function while the other battery is supplying power to the other units of the system. If the operating battery is running low or showing voltage/current levels indicating a fault, the Gatekeeper controller may disconnect this unit and connect the back-up battery to replace the functions of the battery running low on power.

In another configuration an electric power generator is connected to the system which is able to supply enough power that rechargeable batteries in the system are allowed to be charged as long as the electric power generator is connected to the system.

A gatekeeper contains SW-controlled fuses and may further provide current and/or voltage measurement on each port. Information from the Gatekeeper(s) may be collected and managed by a microprocessor or Gatekeeper controller. Preferably, a separate microprocessor or similar computing device which is known to a person skilled in the art is dedicated to the control of the Gatekeepers.

Because the control unit (and possibly also the main processor) may check the status of the Gatekeeper 1 and also set switch/fuse devices 4 of the Gatekeeper 1 to an on-state or off-state it will be possible for the control unit (and possibly also the main processor) to enforce settings of the Gatekeepers which depend on any fused devices, i.e. on any devices being disconnected by the fuse device due to a fault. Hence, a fault dependent and to some extent fault tolerant system is obtainable by using the logic of the program code running in the control unit 7 and/or in the main processor 11.

Typically, a main processor 11 of a Torso (or body) computer runs all application software, such as for example a power management program which polls the Gatekeeper control unit 7 or Power Hub in order to collect information and to calculate and set commands related to the on/off switching of the fuses 4 of the Gatekeepers 1. The power management application typically collects the status for all Gatekeepers 1 including external voltage, current and state of the fuse/switch device 4. This information is stored in a suitable storage module of the body computer and made available to any software application program running on the body or computer.

Preferably, the Gatekeeper 1 control unit 7 or Power Hub has a default operation scheme in order that the body computer may operate even without a power management program.

This invention provides a new potential standard for connecting electronic devices in wearable electronic systems where the electronic devices are allowed to have higher power consumption than what is possible with current standards where signal and power supply are integrated. In order to be able to connect equipment which is not adapted to the standard which is described herein, it is possible to design an adapter which may be regarded as a part of the equipment to be connected. In such a case the adapter is preferably designed with a suitable data conversion module and power supply conversion module and the associated functionality for each type of equipment which is required in order to be able to include such equipment as a part of a system according to this invention. Because adapters can be made physically small they may often be incorporated in the connecting cable or be strapped directly to the equipment to be connected. Thus, non-standard equipment may readily be converted into equipment fitting into the standard system described herein.

An electric power and information system according to this invention utilizing Gatekeepers as described has several advantageous features. First, a system as described minimizes the harm done by one power failure, in that most of the system will be able to continue to operate unaffected by a single power failure.

Secondly, the consequences of an error in a connector or cable may easily be amended by reconfiguring the cabling and harnessing. This is made possible by the fact that the system does not use special interfaces for each connected consumer/provider.

Thirdly, it is possible to disconnect or switch off peripheral units in order to save power and thereby to extend the possible operational lifetime of important system components and in order to better handle critical situations.

Lastly, any exceptional power consumption in the system may be detected and amended before too much power has been wasted.

1-15. (canceled)

16. Electric connect/disconnect device for electronic, wearable equipment and for arrangement between an electric power consuming circuit (2) and an electric power supply module (3) of the electronic, wearable equipment, and adapted for use in managing the energy supply and consumption of the electronic, wearable equipment comprising a controllable switch device (4) which can switch an electric connection (5) from a power consuming circuit (2) to the supply module (3) between a connect state and a disconnect state characterized in that the electric connect/disconnect device also comprises an input/output line (9) for output/input of signals containing information related to the setting and characteristics of the connect/disconnect device, and which is adapted to receive information related to the settings of the input/output device via said input/output line (9), said received information including a setting which depend on any fused devices to enable a fault dependent and fault tolerant overall system.

17. Electric connect/disconnect device according to claim 16, wherein the controllable switch device (4) is arranged between power consuming circuit (2) and an electric power supply module (3)

18. Electric connect/disconnect device according to claim 16, wherein the switch device (4) comprises a current path split in two current paths connected in parallel, a first path for conducting current in one direction and a second path for conducting current in a direction opposite to the current direction of said first path.

19. Electric connect/disconnect device according to claim 18, wherein said first and second current path each comprise a diode function (23,28) for conducting current in one direction, the diode function (23) in the first path being connected in the opposite direction to the diode function (28) in the second path.

20. Electric connect/disconnect device according to claim 18, wherein each of said parallel current paths comprise a separate switch function (24, 27), whereby current can be broken separately in for each parallel path, by a control signal (9) from a control unit (7.)

21. Electric connect/disconnect device according to claim 18, wherein each of said parallel current paths comprise a FET (Field Effect Transistor).

22. Electric connect/disconnect device according to claim 16, wherein the electric connection (5) comprise electric conductors for transfer of communication signals and/or electric power, and wherein electric conductors for transferring communication signals are included in a USB-connection between the supply module (4) and the power consuming circuit (3).

23. Connect/disconnect device according to claim 16, adapted to provide or receive information via said input/output line (9), said information including an on/off status of the electric connections for transfer of electric power.

24. Connect/disconnect device according to claim 23, comprising a voltage sense output (6A) enabling transfer of a signal representing a voltage at the connect/disconnect device to a control unit (7), and a current sense (6B) output enabling transfer of a signal representing a current through the connect/disconnect device to a control unit (7).

25. Connect/disconnect device according to claim 24, wherein the current measuring circuit is adapted to measure current in one or both directions in at least one electric conductor supplying electric power.

26. Wearable electric power and information system comprising an electric power consuming circuit, an electric power supply module, and a connect/disconnect device (1) arranged between the power consuming circuit and the power supply module, the connect/disconnect device (1) comprises a switch device capable switching an electric connection from the power consuming circuit (3) to the supply module (2) between a connect and a disconnect state, said connect and disconnect (1) device being controlled by a control unit (7) of the wearable electronic system characterized in that the connect/disconnect device (1) also comprises a controllable fuse circuit (1) which can break or interrupt electric connections between the power consuming circuit (2) and the power supply module (3).

27. Wearable system according to claim 26, wherein the connect disconnect device (1) is arranged between power consuming circuit (2) and an electric power supply module (3)

28. Wearable system according to claim 26, comprising a power management program code running in a program executing module (7) of the wearable electronic system.
